(19) United States
(12) Patent Application Publication
(10) Pub. No.: US 2012/0062027 A1
(43) Pub. Date: Mar. 15, 2012

(54) Drive System for Vehicles

(76) Inventor: Takafumi Domoto, Tokyo (JP)

(21) Appl. No.: 13/227,131

(22) Filed: Sep. 7, 2011

(30) Foreign Application Priority Data
Sep. 15, 2010 (JP) 2010-207203

(51) Int. Cl. B60L 11/12; H02P 9/04; B60K 6/46

(52) U.S. Cl. 307/9.1; 290/40 B; 180/65.245

(57) ABSTRACT

According to one embodiment, a vehicle drive system has an engine to generate torque. The vehicle drive system has an alternator coupled to the engine. The alternator converts torque from the engine to magnetic flux and generate an AC voltage. The vehicle drive system has a PWM converter coupled to the alternator to convert AC voltage from the alternator to DC voltage. The vehicle drive system has a PWM inverter which is connected with the PWM converters, the PWM inverter is to transform DC voltage to AC voltage. The vehicle drive system has a filter capacitor between the PWM converter and the PWM inverter. The filter capacitor is configured to be charged by the PWM converter.

### CROSS-REFERENCE TO RELATED APPLICATION

This application is based upon and claims the benefit of priority from the prior Japanese Patent Application No. 2010-207203, filed Sep. 15, 2010, the entire contents of which are incorporated herein by reference.

### FIELD

Embodiments described herein relate to drive systems for vehicles.

### BACKGROUND

An electric-powered rail car or other vehicle that operates in a location without sources of an electric power supply (such as from a power line) has an electric power unit to supply electric power to inverter or motor in vehicles.

A power converter transforms the electric power supplied from this electric power unit. The electric motor operates with the alternating current electric power transformed by the power converter. In the drive system for vehicles, when this electric motor drives, vehicles run.

As a rail car which runs a route without sources of an electric power supply, such as wire, the method which forms a battery in an electric power unit is known. However, in the drive system equipped with the battery for vehicles, it is necessary to maintain the charge of the vehicle battery. The charging of the vehicle battery increases the maintenance of the rail car.

### SUMMARY

According to one embodiment, a vehicle drive system has an engine to generate torque. The vehicle drive system has an alternator coupled to the engine. The alternator converts torque from the engine to magnetic flux and generate an AC voltage. The vehicle drive system has a converter coupled to the alternator to convert AC voltage from the alternator to DC voltage. The vehicle drive system has a inverter which is connected with the converter. The inverter is to transform DC voltage to AC voltage. The vehicle drive system has a filter capacitor between the converter and the inverter. The filter capacitor is configured to be charged by the converter, an inverter which is connected with the converter

According to another embodiment, a vehicle includes an engine to generate torque, an alternator coupled to the engine, a converter coupled to the alternator, a filter capacitor between the converter and the inverter, a control circuit to regulate the speed of the engine, an electric motor that is coupled to the inverter, and one or more wheels attached to the at least one axle. The alternator converts torque from the engine to magnetic flux and generate an AC voltage. The converter converts AC voltage from the alternator to DC voltage. The inverter is to transform DC voltage to AC voltage. The filter capacitor is configured to be charged by the converter. The electric motor is configured to rotate and drive a vehicle.

According to another embodiment, a method of driving a vehicle includes generating torque using an engine. The method further includes converting torque from the engine to magnetic flux and generate an AC voltage using an alternator. The method further includes converting AC voltage from the alternator to DC voltage. The method further includes transforming the DC voltage from the alternator to an AC voltage using an inverter. The method further includes providing a filter capacitor between the converter and the inverter, wherein the filter capacitor is configured to be charged by the converter. The method further includes regulating the speed of the engine using a control circuit.

The features and advantages of the present disclosure will be readily apparent to those skilled in the art upon a reading of the description of exemplary embodiments, which follows.

### BRIEF DESCRIPTION OF THE DRAWINGS

FIG. 1 is a figure showing the vehicle drive system according to a first embodiment.

FIG. 2 is a figure showing the vehicle drive system according to a second embodiment.

FIG. 3 is a figure showing the vehicle drive-system according to a third embodiment.

FIG. 4 is a figure showing a vehicle drive-system according to a fourth embodiment.

### DETAILED DESCRIPTION

Various embodiments will be hereinafter explained with reference to the drawings. Throughout the embodiments, the same structures are attached with the same reference numerals, and redundant explanations thereabout are not repeated. Each figure is a schematic view illustrating the embodiments for helping the understanding thereof. In each figure, some of shapes, sizes, ratios, and the like may be different from those in an actual apparatus. As necessary, these may be changed in design in view of the following explanation and known techniques.

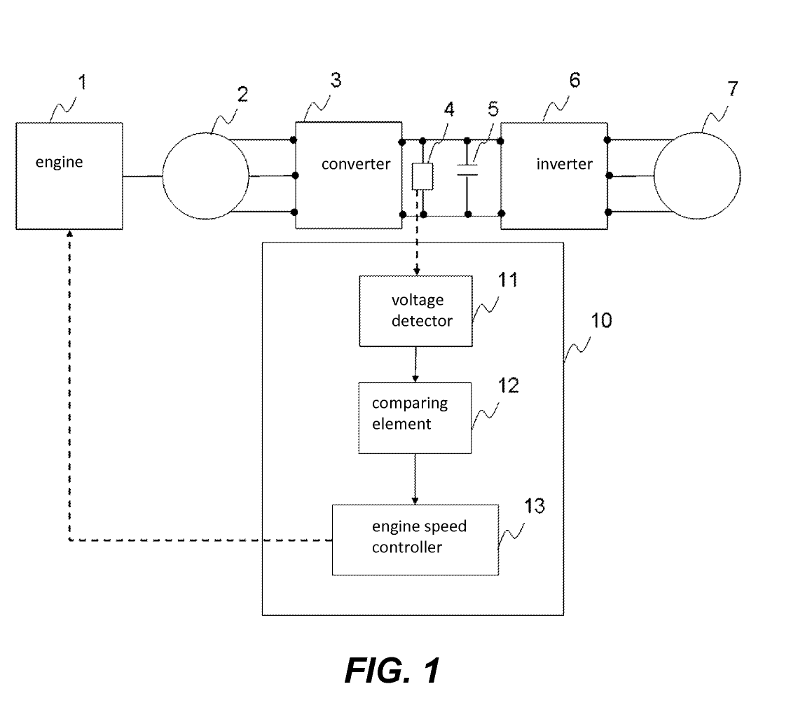

One example embodiment of a drive system for vehicles is shown in FIG. 1. This example embodiment includes an engine 1, alternators 2, converter 3, voltage sensor 4, filter capacitor 5, inverter 6, electric motor 7, control section 10, voltage detector 11, comparing element 12, and engine rotation number commanding part 13.

In the example embodiment, engine 1 is connected with the rotor of alternator 2. The stator winding of alternator 2 is connected with converter 3. Converter 3 is connected with inverter 6 via filter capacitor 5. inverter 6 is connected with electric motor 7. In certain example embodiments converter 3 is a pulse-width modulation (PWM) controlled converter. In certain example embodiments inverter 6 is a PWM controlled inverter. Voltage sensor 4 is connected in parallel with filter 5. Control section 10 is connected with voltage sensor 4. Control section 10 has voltage detector 11, comparing element 12, and engine speed controller 13.

Voltage detector 11 connects with voltage sensor 4 and comparing element 12 within control section 10. Comparing element 12 connects with voltage detector 11 and engine speed controller 13. Engine speed controller 13 is connected with comparing element 12 and engine 1.

Engine 1 is engaged when the vehicle is on. Engine 1 generates torque, which is transmitted to the rotor of alternator 2, rotating the rotor of alternator 2. Alternator 2 is rotated and electric power is generated and sent to converter 3. Filter capacitor 5 is charged by the electric power from converter 3. Once filter capacitor 5 is charged, converter 3 supplies direct-current electric power to inverter 6. inverter 6, in turn, converts the direct-current electric power supplied from converter 3 into alternating current electric power. Electric motor 3 is driven with the alternating current electric power from inverter 6. With the drive of electric motor 3, torque is transmitted via coupling (not illustrated) to an axle to move the vehicle.

To use an alternator 2 as a dynamo, it is necessary for converter 3 to maintain the voltage across filter capacitor 5 at or above a predetermined value.

In order to maintain the voltage across filter capacitor 5 above a predetermined value, the magnetic flux of the rotor of alternator 2 is used. By rotating the rotor of alternator 2 voltage in induced in the stator of alternator 2. Filter capacitor 5 is therefore charged by the output of by converter 3 from alternator 2. By using the residual magnetic flux of a rotor and generating induction voltage, of the voltage across filter capacitor 5 is maintained above a default value, allowing alternator 2 to be used as a dynamo. In this case, filter capacitor 5 can be charged without a separate circuit by using residual magnetic flux.

When alternator 2 is used as a dynamo as mentioned above, the voltage of filter capacitor 5 is controlled by control section 10. The voltage value detected by voltage sensor 4 is relayed to voltage detector 11. The voltage value inputted into voltage detector 11 is inputted into comparing element 12 from voltage detector 11 as voltage value (I). Voltage value (I) inputted into comparing element 12 is compared with a command value (A) previously set by comparing element 12. The command value (A) may be set to the voltage value of the filter capacitor that will allow the drive system to operate.

The comparison result of comparing element 12 is inputted into engine speed controller 13. When the comparison result is “voltage value (I)>command value (A)” (i.e., when the measured voltage is above the command voltage value), the voltage of filter capacitor 5 is assumed to be sufficient to operate the drive system, and engine speed controller 13 causes the engine rotation speed to decreases. When the comparison result is “voltage value (I)<command value (A)” (i.e., when the measured voltage value is less than the command voltage value), the engine speed controller 13 causes the engine rotation speed to increases.

Thus, the minimum voltage of filter capacitor 5 is maintained by the electric power generated with alternator 2 is supplied to electric motor 7, and it enables it to run vehicles.

According to embodiments of the vehicle drive system described above, it may be possible to provide the drive system for vehicles which can run in a location without available power by using engine 1 and converting its output with alternator 2.

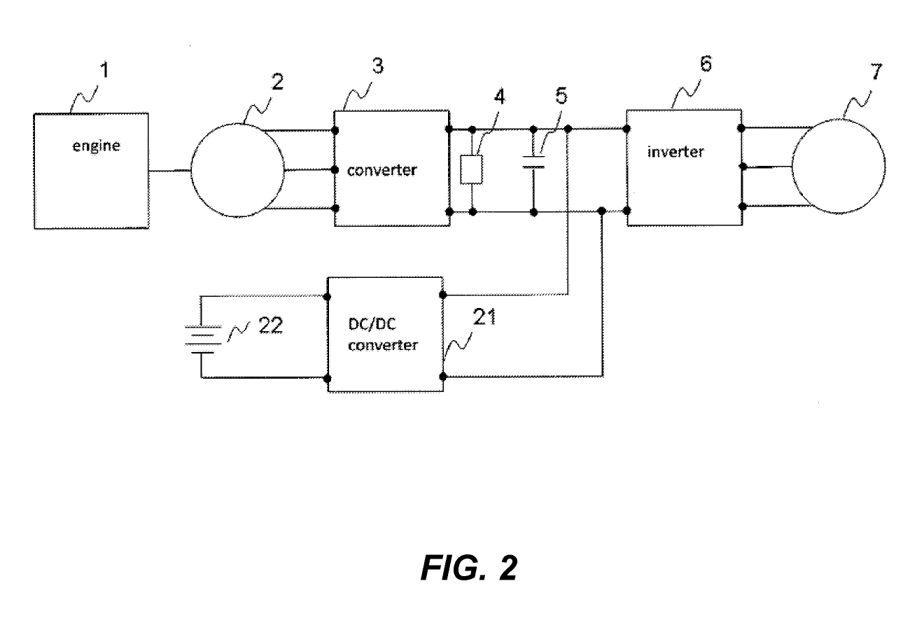

A second example embodiment of a drive system for vehicles is shown in FIG. 2.

In this example embodiment, a DC-to-DC converter 21 is connected with a backup power supply 22. As shown in FIG. 2, between filter capacitor 5 and inverter 6, a backup power supply 22 is connected by DC to DC converter 21.

When the magnetic flux of alternator 2 is insufficient to charge filter capacitor 5, backup power supply 22 charges filter capacitor 5 by the DC-to-DC converter 21.

Alternator 2 can be used as a dynamo once filter capacitor 5 is charged. Thus, the drive system of the second example embodiment can extend a period of maintenance work by using the backup power source less frequency than an example system that relied more on the backup power supply 22.

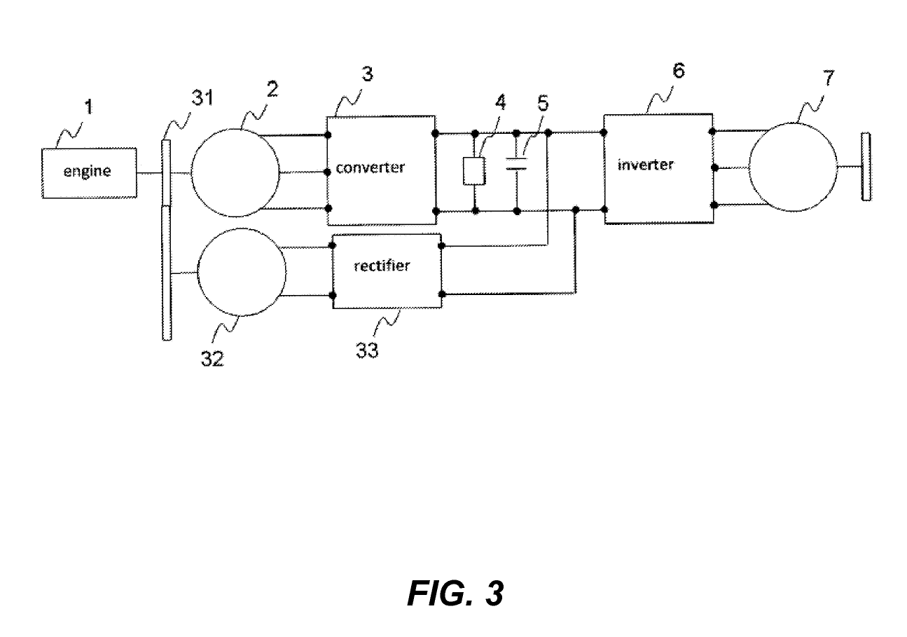

A second example embodiment of a drive system for vehicles is shown in FIG. 3 A third example embodiment is shown in FIG. 3. The third example embodiment differs from the second example embodiment in that it has a first gear 31, a dynamo 32, and a rectifier 33.

As shown in FIG. 3, the first gear 31 is connected to engine 1. The other end of the first gear 31 is connected to, alternator 2 and dynamo 32. Dynamo 3 is connected with rectifier 33. Rectifier 33 is connected between filter capacitor 5 and inverter 6.

Engine 1 is engaged when control section 10 determines that the residual magnetic flux of alternator 2 is insufficient to charge filter capacitor 5. When engine 1 is engaged, torque is transmitted to dynamo 32 by the first gear 31. Dynamo 32 rotates by the torque transmitted from the first gear. Dynamo 32's rotation generates alternating current electric power occurs. Alternating current electric power generated from dynamo 32 is rectified by rectifier 33 and is then supplied to filter capacitor 5. Once filter capacitor 5 is fully charged, the vehicle drive system will operate.

In certain example embodiments, a transformer may be inserted between dynamo 32 and rectifier 33 to adjust the output voltage of dynamo 32.

In certain embodiments from the output from alternator 32 is an alternating current. In other example embodiments a direct current generator is used.

According to embodiments of the vehicle drive system described above, it may be possible to provide the drive system for electric-powered vehicles that will allow the vehicle to operate in a location that does not have external power.

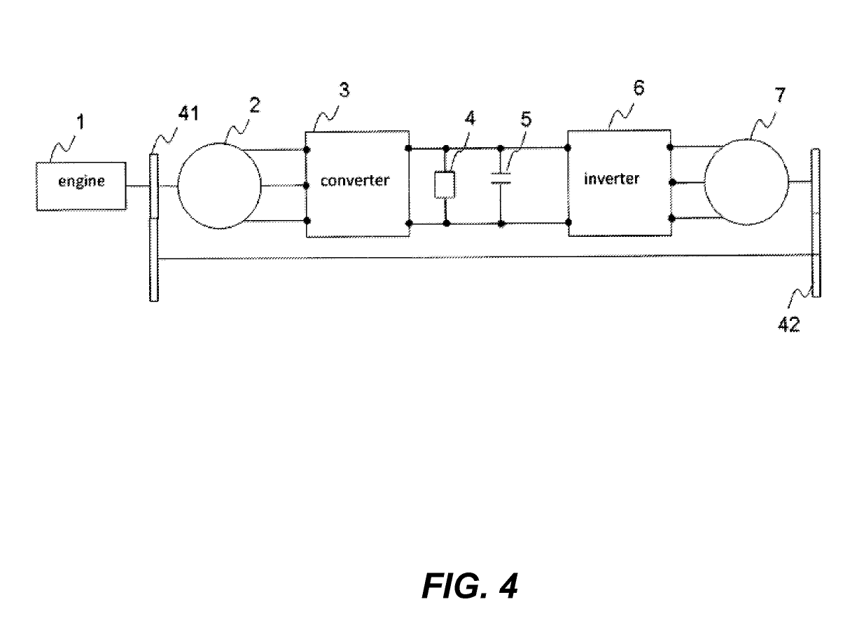

A fourth example embodiment of the drive system is show in FIG. 4.

In this example embodiment, first gear 41 and second gear 42 are connected.

The first gear is connected between engine 1 and alternator 2. Electric motor 7 is mechanically connected with second gear 42. The first gear 41 and second gear 42 are connected mechanically.

Engine 1 is engaged when control section 10 determines the residual magnetic flux of alternator 2 is insufficient to charge filter capacitor 5. When engine 1 is engaged, the first gear 41 is rotated. Torque is transmitted to second gear 42. The rotation of the second gear 42 will, in turn, cause torque and rotation of electric motor 7. The rotation of electric motor 7, in turn, generates alternating current electric. In this example embodiment, electric power generated by electric motor 7 is then supplied to PWM inverter 6. The alternating current electric power of electric motor 7 is transformed into direct-current electric power by PWM inverter 6. This direct-current electric power charges filter capacitor 5. Once filter capacitor 5 is fully charged, the drive system is set to operate.

In this embodiment the filter capacitor 5 can be fully charged even when the residual magnetic flux of alternator 2 is insufficient to charge filter capacitor 2.

According to embodiments of the vehicle drive system described above, it may be possible to provide the drive system for electric-powered vehicles that will allow the vehicle to operate in a location that does not have external power. It may also be possible to avoid the maintenance of having to charge a power supply in the drive system.

While certain embodiments of a vehicle drive system have been described, these embodiments have been presented by way of example only, and are not intended to limit the scope of the disclosure. Indeed, the novel systems described herein may be embodied in a variety of other forms; furthermore, various omissions, substitutions and changes in the form of the systems described herein may be made without departing from the spirit of the disclosure. The accompanying claims and their equivalent are intended to cover such forms or modifications as would fall within the scope and spirit of the disclosure.

What is claimed is:

1. A vehicle drive system comprising:
an engine to generate torque;
an alternator coupled to the engine, the alternator to convert torque from the engine to magnetic flux and generate an AC voltage;
a converter coupled to the alternator, the converter to convert AC voltage from the alternator to DC voltage;
an inverter connected with the converter, the inverter to transform DC voltage to AC voltage;
a filter capacitor between the converter and the inverter, wherein the filter capacitor is configured to be charged by the converter; and
a control circuit to regulate the speed of the engine.

2. The vehicle drive system of claim 1, wherein the inverter is a PWM inverter and the converter is a PWM converter.

3. The vehicle drive system of claim 1, further comprising:
an electric motor that is coupled to the inverter, wherein the electric motor is configured to rotate and drive a vehicle.

4. The vehicle drive system of claim 1, further comprising:
a voltage sensor configured to measure a voltage across the filter capacitor; and
wherein the control circuit is coupled with the voltage sensor and configured to regulate the speed of the engine, based, at least in part, on the voltage measured by the voltage sensor.

5. The vehicle drive system of claim 4, wherein the control circuit is configured to increase the engine speed when the voltage measured by the voltage sensor is below a predetermined voltage.

6. The vehicle drive system of claim 4, wherein the control circuit is configured to decrease the engine speed when the voltage measured by the voltage sensor is below a predetermined voltage.

7. The vehicle drive system of claim 1, further comprising:
a backup power source that is connected between the filter capacitor and the inverter;
a DC/DC converter that is coupled to the backup power source, wherein the DC/DC converter rectifies the power from the backup power source; and
wherein the backup power source is configured to charge the filter capacitor when the voltage across the filter capacitor drops below a predetermined value.

8. The vehicle drive system of claim 1, further comprising:
a dynamo that is coupled to the engine, wherein the dynamo is configured to supply electric power to the filter capacitor; and
a first gear that is connected between the dynamo and the alternator, where the first gear is configured to:
transmit torque from the engine to the alternator; and transmit torque from the engine to the to the dynamo.

9. The vehicle drive system of claim 1, further comprising:
an electric motor that is coupled to the inverter;
a first gear that is connected between the engine and the alternator; and
a second gear that is connected to the first gear and the electric motor.

10. A vehicle comprising:
an engine to generate torque;
an alternator coupled to the engine, the alternator to convert torque from the engine to magnetic flux and generate an AC voltage;
a converter coupled to the alternator, the converter to convert AC voltage from the alternator to DC voltage;
an inverter which is connected with the converter, the inverter is to transform DC voltage to AC voltage; and
a filter capacitor between the converter and the inverter, wherein the filter capacitor is configured to be charged by the converter;
a control circuit to regulate the speed of the engine;
an electric motor that is coupled to the inverter;
at least one axle, wherein the electric motor is configured to turn the axle; and
one or more wheels attached to the at least one axle.

11. The vehicle 10, further comprising:
a voltage sensor configured to measure a voltage across the filter capacitor; and
wherein the control circuit is coupled with the voltage sensor and configured to regulate the speed of the engine, based, at least in part, on the voltage measured by the voltage sensor.

12. The vehicle drive system of claim 10, further comprising:
a backup power source that is connected between the filter capacitor and the inverter;
a DC/DC converter that is coupled to the backup power source, wherein the DC/DC converter rectifies the power from the backup power source; and
wherein the backup power source is configured to charge the filter capacitor when the voltage of the filter capacitor drops below a predetermined value.

13. The vehicle drive system of claim 9 further comprising:
a dynamo that is coupled to the engine, wherein the dynamo is configured to supply electric power to the filter capacitor; and
a first gear that is connected between the dynamo and the alternator, where the first gear is configured to:
transmit torque from the engine to the alternator; and transmit torque from the engine to the to the dynamo.

14. A method of driving a vehicle comprising:
generating torque using an engine;
converting torque from the engine to magnetic flux and generate an AC voltage using an alternator;
converting AC voltage from the alternator to DC voltage;
transforming the DC voltage from the alternator to an AC voltage using an inverter;
providing a filter capacitor between the converter and the inverter, wherein the filter capacitor is configured to be charged by the converter; and
regulating the speed of the engine using a control circuit.

15. The method of claim 14, further comprising:
providing an electric motor that is coupled to the inverter, wherein the electric motor is configured to rotate and drive a vehicle.

16. The method of claim 14, further comprising:
measuring a voltage across the filter capacitor; and
wherein regulating the speed of the engine is, based, at least in part, on the voltage measured by the voltage sensor.

17. The method of claim 16, wherein regulating the speed of the engine comprises increasing the engine speed when the voltage measured by the voltage sensor is below a predetermined voltage.

18. The method of claim 16, wherein regulating the speed of the engine comprises decreasing the engine speed when the voltage measured by the voltage sensor is below a predetermined voltage.

19. The method of claim 14, further comprising:
providing a backup power source that is connected between the filter capacitor and the inverter;
rectifying the power from the backup power source using a DC/DC converter; and
wherein the backup power source is configured to charge the filter capacitor when the voltage across the filter capacitor drops below a predetermined value.

20. The method of claim 14, further comprising:
supplying electric power to the filter capacitor using a dynamo; and
transmitting torque from the engine to the alternator using a first gear; and
transmitting torque from the engine to the to the dynamo using the first gear.
